(19) United States
(12) Patent Application Publication
(10) Pub. No.: US 2014/0075674 A1
(43) Pub. Date: Mar. 20, 2014

(54) FOLDING TYPE BED FOR MEDICAL USE

(71) Applicant: KOREA INSTITUTE OF INDUSTRIAL TECHNOLOGY, Cheonan (KR)

(72) Inventors: Keyoung Jin Chun, Uiwang (KR); Young Chan Kwak, Bucheon (KR); Hyun Ho Choi, Anyang (KR)

(21) Appl. No.: 13/988,329

(22) PCT Filed: Oct. 2, 2012
(86) PCT No.: PCT/KR2012/007980

§ 371 Date: May 18, 2013

(30) Foreign Application Priority Data
Oct. 14, 2011 (KR) 10-2011-0105188

(51) Int. Cl. A61G 7/015; A61G 7/018

(52) U.S. Cl. CPC A61G 7/015; A61G 7/018
USPC 5/618; 5/617

(57) ABSTRACT

There is disclosed a folding type bed including a support frame, a main frame coupled to the support frame, a back support part provided on the main frame, a central support part of which the length is adjustable by an external force on the main frame, a first driving module coupled to the main frame or the support frame, a rotary member rotatably coupled the main frame and coupled to the other end of the first driving module, spaced apart a predetermined distance from a coupling shaft with the main frame, and a first connection module slidingly coupled to the back support part and rotatably coupled to the central support part simultaneously, to rotate the rotary member when the first driving module is extended so as to tilt one portion of the back support part and to slidingly move the central support part simultaneously.

### TECHNICAL FIELD

The present invention relates to a folding type bed for medical use, more particularly, to a folding type bed for medical use of which a back has one portion configured to be tilted upward by using a driving module provided therein and the other portion configured to slide along a main frame to prevent separation of the back side, such that a pressure applied to a user's abdomen can be reduced as much as possible.

### BACKGROUND ART

Generally, fixed type beds are used that have fixed appearance and height. However, in case of being used in a hospital, even such a fixed type bed can be transformable to allow the head, legs, waist and a human body part tilted upward and downward, considering a patient's state.

The bed used for a patient who is not able to move about freely has a structure allowing him or her to adjust an angle of a back upward to provide use convenience and to adjust an angle of a mattress located under the patient's legs manually or electrically, separate from the back of the bed.

Accordingly, the patient not able to move about freely lifts one side of the mattress to watch TV, read books and take a rest. Such the mattress angle adjusting structure is realized by the upward/downward motion of a screw shaft. The upward/downward motion of the screw shaft is enabled by rotation of a driving motor. The patient controls an operation time of the driving motor to adjust the angle and uses the bed conveniently.

In the patient bed mentioned above, an angle of a lower portion is adjustable manually or by the driving motor. Recently, beds having an automatic angle adjusting structure are adopted because of the inconvenience caused by the manual operation.

To enhance the convenience and usability of the conventional bed, various motorized adjustable beds have been under development.

Referring to FIGS. 1 and 2, Korean Patent Registration No. 10-0621349 as one example of the conventional motorized adjustable beds will be described as follows.

FIG. 1 is a perspective diagram illustrating a structure of a conventional motorized adjustable bed and FIG. 2 is a diagram illustrating an operation of the bed shown in FIG. 1.

As shown in the drawings, the conventional motorized adjustable bed includes a bed frame 10, an operation module 20 provided on the bed frame 10, with a back support part 21 and a leg support part 22 that are rotatably coupled to each other, a driving module (30, see FIG. 2) rotatably coupled to the operation module, with a plurality of links rotatably drivable by an external force, and a power module (40, see FIG. 2) provided under the bed frame 10 to provide the external force for the operation of the driving module 30.

The bed frame 10 is configured to support an entire portion of the operation module 20, in a state of being positioned under the operation module 20. The bed frame 10 includes one portion having the driving module 30 rotatably coupled thereto.

The operation module 20 is configured of a plurality of members and the plurality of the members are positioned corresponding to a user's body parts, respectively. Each of the members is tilted by the operation of the operation module 20. The operation module 20 includes a back support part 21, a femoral region support part 22a, a shin support part 22b and a footrest part 22c.

The driving module 30 is configured of the plurality of the links provided under the bed frame 10 to be hingedly coupled to each other. The driving module 30 adjusts a state of the operation module 20 by using the external force provided by the power module 40.

The power module 40 includes a first actuator (41, see FIG. 2) and a second actuator (42, see FIG. 2). The first actuator 41 applies a power for tilting the back support part 21 and the second actuator 42 applies a power for tilting the leg support part 22.

The back support part 21 is positioned on a top surface of the bed frame 10 and one end of the back support part 21 is rotatably coupled to a fixing part 50 provided in the bed frame 10 to allow the other end tilted by the driving module 30.

The femoral region support part 22a has one end rotatably coupled to the other end of the fixing part 40 and one end of the shin support part 22b is rotatably coupled to the other end of the femoral region support part 22a.

The footrest part 22 is tilted upward by the driving module 30 coupled to the bed frame 10.

The driving module 30 includes a first link (31, see FIG. 2) configured to adjust the tilting of the back support part 21 based on the extension of the first actuator 41 and a second link (31, see FIG. 2) configured to adjust the tilting of the footrest part 22 based on the extension of the second actuator 42.

The first link 31 includes a first driving link (31a, see FIG. 2) having one portion rotatably coupled to a back side of the back support part 21 and a first auxiliary link (31b, see FIG. 2) having one portion rotatably coupled to the other portion of the first driving link (31a, see FIG. 2) and to the first actuator 41 and the other portion rotatably coupled to the bed frame 10.

The second link 32 includes a second driving link (32a, see FIG. 2) having one portion rotatably coupled to a back side of the footrest part 22 and a second auxiliary link (32b, see FIG. 2) having one portion rotatably coupled to the other portion of the second driving link 32a, a middle portion rotatably coupled to the second actuator 42 and the other portion rotatably coupled to the bed frame 10.

In addition, the second link 32 further includes a support link (32c, see FIG. 2) having one portion rotatably coupled to the middle portion of the second driving link 32a and the other portion rotatably coupled to the back side of the bed frame 10, to support the second driving link 31a.

Referring to FIG. 2, the driving of the folding type bed according to the present invention will be described in detail as follows.

First of all, when the first actuator 41 and the second actuator 42 as shown in FIG. 2 (a), the first driving link 31a and the first auxiliary link 31b connected to the first actuator 41 are rotated in different directions, respectively, and the first driving link 31a is rotated in a clockwise direction. When the first driving link 31a is rotated in the clockwise direction, the back support part 21 is tilted toward the bed frame 10 and it is secured to the top surface of the bed, in parallel with the bed frame 10.

Together with that, as the second actuator 42 is contracting, the second auxiliary link 32b connected to the second actuator 42 is rotated in a counter-clockwise direction and the second driving link 32a connected to the second auxiliary link 32b is rotated in the counter-clockwise direction to move downward.

The footrest part 22 is tilted downward by the driving of the second driving link 32a such that it can be secured to the top surface of the bed frame 10, in parallel to the bed frame 10.

Next, while the first actuator 41 and the second actuator 42 are extended, the first driving link 41a is rotated in the counter-clockwise and an outer portion of the back support part 21 is tilted upward by the driving of the first driving link 31a.

Together with that, the second actuator 42 is extended, the second auxiliary link 32b connected to the second actuator 42 is rotated in the clockwise direction and the second driving link 32a connected to the second auxiliary link 32b is rotated in the counter-clockwise direction to be tilted upward.

The driving of the back support part 21 and the footrest part 22 is described above, referring to FIG. 2.

However, when the back support part 21 is tilted upward in the conventional motorized adjustable bed, only the tilting angle can be performed basically. Accordingly, a predetermined pressure might be applied to the user's abdomen seated on a top surface of the bed disadvantageously.

### DISCLOSURE

### Technical Problem

The present invention is directed to solve problems of the conventional motorized adjustable bed. An object of the present invention is to provide a folding type bed for medical use that includes a tilted back support part and further a central support part rotatably coupled to the back support part, with an adjustable length, such that the central support part may slide to make the length increased in case the back support part is tilted, only to reduce a user's abdominal pressure.

### Technical Solution

To achieve these objects and other advantages and in accordance with the purpose of the embodiments, as embodied and broadly described herein, a folding type bed includes a support frame; a main frame coupled to the support frame 100 to be supported by the support frame at a predetermined height from the ground; a back support part provided on the main frame, with one end slidable on the main frame; a central support part of which the length is adjustable by an external force on the main frame, with one end rotatably coupled to one end of the back support part; a first driving module coupled to the main frame or the support frame, in a state of being extendible in one direction; a rotary member rotatably coupled the main frame and coupled to the other end of the first driving module, spaced apart a predetermined distance from a coupling shaft with the main frame, to be rotated by the extension of the first driving module; and a first connection module slidingly coupled to the back support part and rotatably coupled to the central support part simultaneously, in a state of connected with the rotary member, to rotate the rotary member when the first driving module is extended so as to tilt one portion of the back support part and to slidingly move the central support part simultaneously.

The first connection module may include an operation link comprising a middle portion fixedly coupled to the rotary member and one end slidably coupled to a back side of the back support part; and an extension link comprising one end rotatably coupled to the other end of the operation link and the other end rotatably coupled to the central support part.

The extension link may be extendible.

The central support part may include a plurality of members that are slidable with each other and one of the members located outer may include one end rotatably coupled to the back support part.

The central support part may further include an extension frame slidably provided therein to slide by an external force, without separating from the central support part.

The folding type bed may further include a footrest part provided on the other portion of the main frame where the back support part is not located, with a middle portion that is able to tilt upward, with making one end not separated from the main frame; a second driving module configured to tilt the middle portion of the footrest part simultaneously with the motion of the footrest part along the main frame; and a second connection module comprising one portion slidably coupled to a back side of the footrest, the other portion rotatably coupled to the second driving module and a middle portion rotatably coupled to the main frame.

The footrest part may include a plurality of members arranged on the main frame in series, in a state of being rotatably coupled to each other.

The outermost one of the members may be slidably coupled to the main frame to slide simultaneously with the tilting of the footrest part.

The first driving module and the second driving module may have the same structure.

In another aspect of the present invention, a folding type bed includes a support frame; a main frame coupled to the support frame 100 to be supported by the support frame at a predetermined height from the ground; a back support part provided on the main frame, with one end slidable on the main frame; a first driving module coupled to the main frame or the support frame, in a state of being extendible in one direction; a rotary member rotatably coupled the main frame and coupled to the other end of the first driving module, spaced apart a predetermined distance from a coupling shaft with the main frame, to be rotated by the extension of the first driving module; and a first connection module slidingly coupled to the back support part and rotatably coupled to one end of the back support part simultaneously, in a state of connected with the rotary member to rotate the rotary member when the first driving module is extended, so as to tilt one portion of the back support part and to slidingly move the back support part simultaneously.

The first connection module may include an operation link comprising a middle portion fixedly coupled to the rotary member and one end slidably coupled to a back side of the back support part; and an extension link comprising one end rotatably coupled to the other end of the operation link and the other end rotatably coupled to the central support part.

The extension link may be extendible.

The folding type bed may further include a footrest part provided on the other portion of the main frame where the back support part is not located, with a middle portion that is able to tilt upward, with making one end not separated from the main frame; a second driving module configured to tilt the middle portion of the footrest part simultaneously with the motion of the footrest part along the main frame; and a second connection module comprising one portion slidably coupled to a back side of the footrest, the other portion rotatably coupled to the second driving module and a middle portion rotatably coupled to the main frame.

The footrest part may include a plurality of members arranged on the main frame in series, in a state of being rotatably coupled to each other.

The outermost one of the members may be slidably coupled to the main frame to slide simultaneously with the tilting of the footrest part.

The first driving module and the second driving module may have the same structure.

### Advantageous Effects

The present invention has following advantageous effects.

The length of the central support part where the user's abdomen is positioned can be adjustable. When the driving module is operated, the back support is tilted upward by the connection module connected to the driving module and the length of the central support part is adjusted simultaneously. Accordingly, the pressure applied to the user's abdomen seated on the bed can be minimized effectively.

### DESCRIPTION OF DRAWINGS

FIG. 1 is a perspective diagram illustrating a structure of a conventional motorized adjustable bed;

FIG. 2 is a diagram illustrating an operation of the bed shown in FIG. 1;

FIG. 3 is a perspective diagram illustrating a structure of a folding type bed according to one embodiment of the present invention;

FIG. 4 is an exploded perspective diagram illustrating the structure of the folding type bed shown in FIG. 3;

FIG. 5 is a diagram illustrating an operation of a back support part shown in FIG. 3;

FIG. 6 is a diagram illustrating an operation of a footrest part shown in FIG. 3;

FIG. 7 is a side view illustrating an variation of the central support part shown in FIG. 3;

FIG. 8 is a perspective diagram illustrating a structure of a folding type bed according to a second embodiment of the present invention; and

FIG. 9 is a diagram illustrating an operation of a back support part shown in FIG. 8.

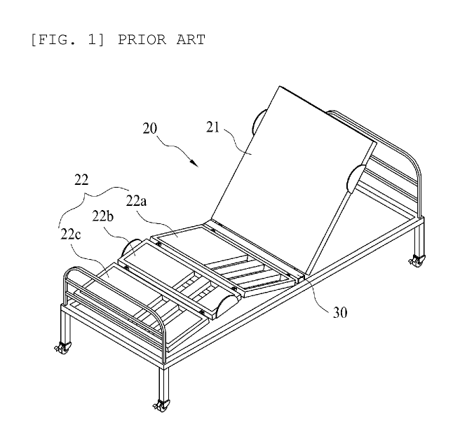

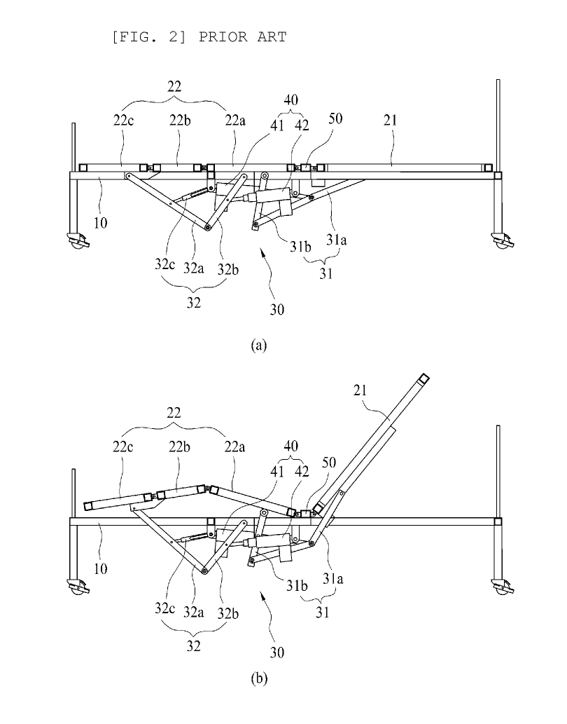

### BEST MODE

Referring to the accompanying drawings, a folding type bed for medical use according to embodiments of the present invention will be described. Various embodiments of a fission product trapping pellet with ceramic microcells arranged therein and a fabricating method thereof will be described as follows, referring to the accompanying drawings.

Reference will now be made in detail to the specific embodiments of the present invention, examples of which are illustrated in the accompanying drawings. Wherever possible, the same reference numbers will be used throughout the drawings to refer to the same or like parts.

### First Embodiment

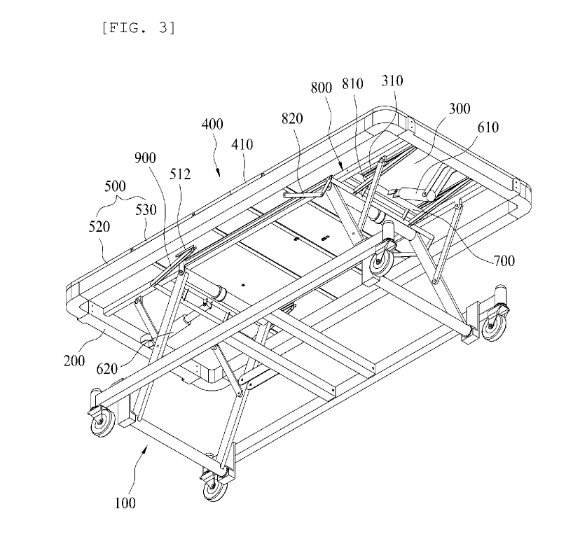

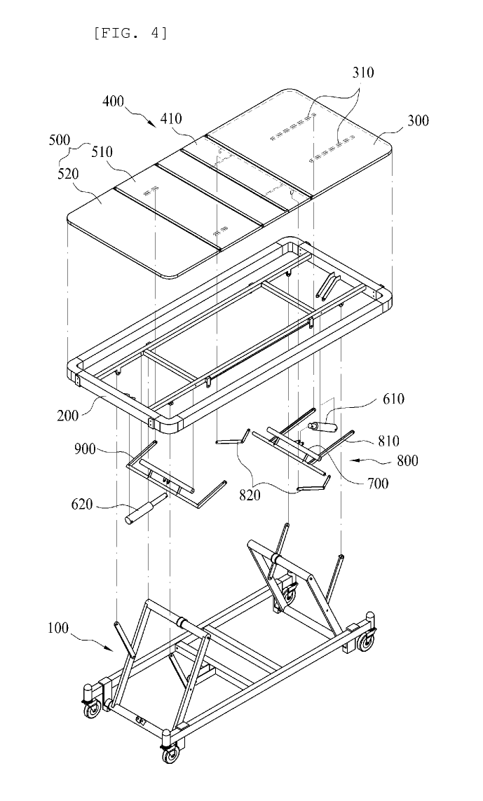

First of all, referring to FIGS. 3 and 4, a structure of a folding type bed for medical use according to a first embodiment of the present invention will be described as follows.

FIG. 3 is a perspective diagram illustrating a structure of a folding type bed according to one embodiment of the present invention. FIG. 4 is an exploded perspective diagram illustrating the structure of the folding type bed shown in FIG. 3.

The folding type bed according to the first embodiment includes a support frame 100 provided in a lower portion thereof to support a structure arranged in an upper portion; a main frame 200 coupled to a top of the support frame 100; a back support part 300 provided on the main frame 200; a central support part 400 provided on the main frame 200, in a state of being rotatably coupled to the back support part 300; a footrest part 500 provided on the main frame in a state of being rotatably coupled to the other portion of the back support part 300; a first driving module coupled to the main frame 200 or the support frame 100, in a state of being extendible; a second driving module 620, a rotary member 700 rotatable by the first driving module 610; a first connection module 800 configured to tilt one portion of the back support part 300 according to the rotation of the first rotary member 700; and a second connection module 900 configured to adjust a driving state of the footrest part 500 according to the second driving module 620.

According to this embodiment, a bed (not shown) is seated on the main frame 200. When an adult user is lying on the bed, with the back in contact with the bed, the height from the head to the foot is referenced to as ‘a longitudinal direction of the bed’ and the longitudinal direction of the bed is identical to a longitudinal direction of the main frame 200.

The main frame 200 is coupled to the support frame 100 to be supported distant from the ground more than a predetermined height.

The back support part 300 is provided on the main frame 200 and one end of the back support part 300 is able to slide along a longitudinal frame 200.

The central support part 400 is provided on a top of the main frame 200 and it has the length that is changeable by an external force. Also, one end of the central support part 400 is rotatably coupled to one end of the back support part 300.

The central support part 400 is configured of a plurality of sliding members and one sliding member 410 located closest to the back support part 300 is sliding by the external force such that the length of the central support part 400 can be adjusted.

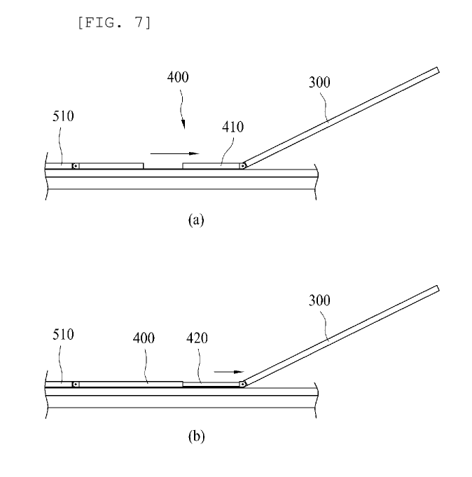

A variation of the central support part 400 will be described later, referring to FIG. 7.

The footrest part 500 is located on the other portion of the main frame 200 rather than the portion where the back support part 300 is positioned and the footrest part 500 is hingedly coupled to the central support part 400 to make a middle portion of the footrest part 500 tilted upward, without separation of one end along the main frame 200.

The footrest part 500 may be configured of a plurality of members. In this embodiment, the footrest part 500 is configured of first and second footrest members 510 and 520 and this configuration is to make the present invention understood more clearly and the present invention is not limited thereto.

The first footrest member 510 has one end rotatably coupled to the central support part 400 and the other end rotatably coupled to one end of the second footrest member 520. The other end of the second footrest member 520 is coupled to the main frame, in a state where it is able to slide along the main frame.

The first driving module 610 may be an actuator coupled to the main frame 200 or the support frame 100, in a state of being extendible. The first driving module 610 extends or restitutes to rotate the first connection module 800.

The second module 610 may be an actuator, similar to the first driving module 610. However, the actuator as the second module 610 is connected with the second connection module 900 and it extends or restitutes to rotate the second connection module 900.

Here, the actuators are selected as the first driving module 610 and the second driving module 620. However, the first and second driving modules are not limited to the actuators and they can be any configurations capable of transferring the external force to rotate the first and second connection modules 800 and 900.

The rotary member 700 is located under the back support part 300, to rotate along a traverse direction of the main frame 200. A bracket is projected from a central portion of the rotary member 700 to be rotatably coupled to the first driving module 610 such that the rotary member 700 may be rotated by the extension of the first driving module 610. Together with that, the rotary member 700 is fixedly coupled to the first connection module 800 to make the first connection module 800 driven together.

The first connection module 800 includes an operation link 810 rotated by the rotation of the rotary member 700, with one end slidingly coupled to a back side of the back support part 300, and an extended link rotatably coupled to the other end of the operation link 810 to be driven together with the operation link 810.

The second connection module 900 has one end slidingly coupled to a back side of the first footrest member 510, the other end rotatably coupled to the second driving module 620, and a middle portion rotatably couple to the main frame 200 to be rotated by the extension of the second driving module 620.

Accordingly, an operational state of the first connection module 800 is determined by the operation of the first driving module 610 and an operational state of the second connection module 900 is determined by the operation of the second driving module 620.

Next, referring to FIG. 4, the structure of the folding type bed according to this embodiment will be described in detail as follows.

In case the operation link 810 of the first connection module 800 slidably coupled to the back side of the back support part 300 is operated by the external force, one portion of the back support portion 300 is configured to be tilted upward by the operation of the operation link 810.

The operation link 810 is coupled to the rotary member 700 rotatably coupled to the main frame 200 along a traverse direction. When the rotary member 700 is rotated, the operation link 810 is rotated together.

The rotary member 700 is rotatably coupled to the first driving module 610 such that the rotary member 700 can be rotated along the extension of the first driving module 610.

In addition, the sliding member 410 is rotatably coupled to the extension link 820 and the end of the extension link 820 is coupled to the operation link 810. In case the operation link 810 is operated, the extension link 820 is operated together to slide the sliding member 410 such that the length of the central support part 400 can be adjusted.

With this structure, the back support part 300 is tilted by the operation of the first driving module 610 and the central support part 400 is sliding simultaneously, such that the length of the central support part 400 can be adjusted.

Here, the extension link 820 is configured to be extendible for smooth operation, in case the back support part 300 is tilted and the sliding member 410 is sliding simultaneously. Accordingly, sudden stop of the operation link 810 can be prevented once it starts the rotation.

The footrest part 500 is configured of two members. One end of the second connection module is slidably coupled to a back side of the first footrest member 510 adjacent to the central support part 400. The operations of the first and second footrest members 510 and 520 can be determined based on the operation of the second connection module 900.

One end of the second connection module 900 is slidably coupled to the back side of the first footrest 510 and the other end of the second connection module 900 is rotatably coupled to the second driving module 620. Also, the middle portion of the second connection module 620 is rotatably coupled to the main frame 200. Accordingly, the operational state of the second connection module 900 may be determined based on the extension of the second driving module 620.

One end of the first footrest member 510 is rotatably coupled to the central support part 400 and the other end of the first footrest member 510 is able to be tilted upward by the second connection module 900. One end of the second footrest member 520 is rotatably coupled to the other end of the first footrest part 510. In case the first footrest member 510 is tilted upward, the other end of the second footrest member 520 is tilted downward.

The middle portion of the footrest part 500 configured of the two members is tilted upward by the second connection module 900 and the opposite ends thereof connected to the main frame 200 are tilted downward.

With such the structure, the middle portion of the footrest part 500 may be tilted upward by the operation of the second driving module 620.

In this embodiment mentioned above, the footrest part 500 is configured of two members. However, this is selected to make the embodiment understood more clearly and the number of the members according to the embodiment is not limited to the two members. Only if the middle portion of the footrest part 500 is tilted upward and the opposite ends downward of the footrest part 500, the number of the footrest members can be changeable freely.

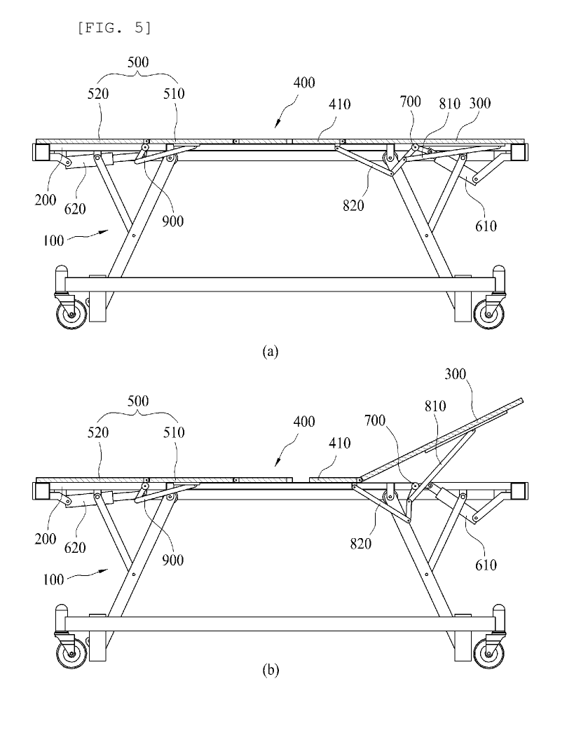

Next, referring to FIG. 5, the operation of the back support part 300 will be described as follows.

FIG. 5 is a diagram illustrating an operation of a back support part shown in FIG. 3.

First of all, in case the first driving module 610 is contracted, the rotary member 700 is rotated in a clockwise direction. When the rotary member 700 is rotated in the clockwise direction, the operation link 810 having one portion fixedly coupled to the rotary member 700 is rotated in the clockwise direction together with the rotary member 700.

Simultaneously, the extension link 820 rotatably coupled to the rotary member 700 is rotated in a counter-clockwise direction and the sliding member 10 of the central support part 400 located closest to the back support part 300 is moved to the left.

Once the operation link 810 is rotated in the clockwise direction, the back support part 300 is located on the top surface of the main frame, in parallel with the main frame 200, and the central support part 400 is contracted by the extension link 820.

Hence, when the first driving module 610 is extended, the rotary member 700 is rotated in the counter-clockwise direction as shown in FIG. 5 (b). When the rotary member 700 is rotated in the counter-clockwise direction, the operation link 810 fixedly coupled to the rotary member 700 is rotated in the counter-clockwise direction together with the rotary member 700.

Once the operation link 810 is rotated in the counter-clockwise direction, one end of the operation link 810 is sliding inward along a first guide 310 provided in the back side of the back support part 300 and the end of the operation link 810 applies the external force to the back support part 300 to tilt the back support part 300 upward.

Together with that, the extension link 820 coupled to the rotary member 700 is rotated on a shaft in the clockwise direction and the sliding member 410 of the central support part 400 located closest to the back support part 300 is moved to the right by the rotation of the extension link 820.

Here, the end of the back support part 300 rotatably coupled to be rotated together with the rightward motion of the sliding member 410 is sliding to the right along the main frame 200.

Under this structure, one end of the back support part 300 is tilted upward by the operation of the first driving module 610 and the other end of the back support part 300 is sliding rightward simultaneously.

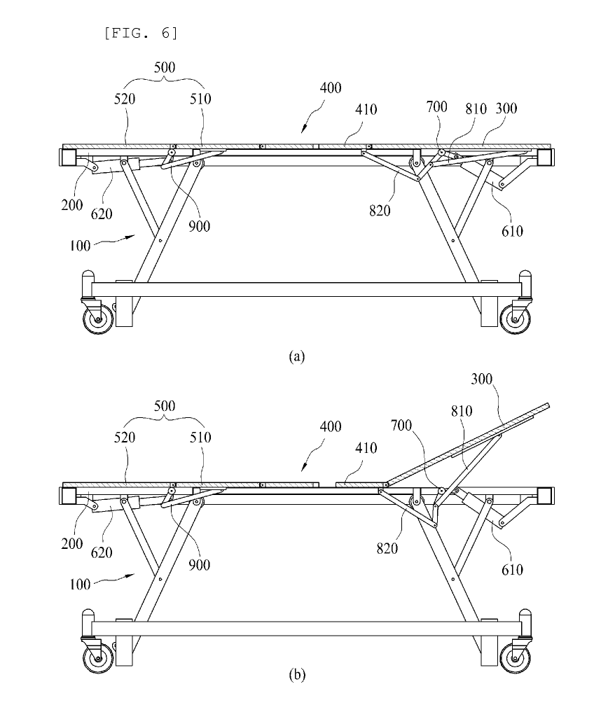

Next, referring to FIG. 6, the operation of the footrest part 500 will be described as follows.

FIG. 6 is a diagram illustrating the operation of the footrest part shown in FIG. 3.

First of all, in case the second driving module 620 contracts as shown in FIG. 6 (a), the second connection module 900 is rotated in the clockwise direction. When the second connection module 900 is rotated in the clockwise direction, one portion of the second connection module 900 is moved rightward along a second guide 512 provided in a back side of the first footrest member 510 and the first footrest member 510 is rotated in the counter-clockwise direction to be positioned in parallel with the main frame 200. Together with that, the second footrest member 520 is rotated in the reverse direction of the first footrest member 510 to be positioned in parallel with the main frame 200.

Hence, in case the second driving module 620 is extended, the second driving module 620 is rotated in the counter-clockwise direction as shown in FIG. 6 (b). when the second driving module 620 is rotated in the counter-clockwise direction, one portion of the second driving module 620 is moved leftward along the second guide 512 provided in the back side of the first footrest member 510 and an external force is applied to rotate the first footrest member 510 in the counter-clockwise direction simultaneously.

When the first footrest member 510 is tilted in the clockwise direction by the second driving module 620, the second footrest member 520 rotatably coupled to the first footrest member 510 is rotated in the reverse direction.

When the second driving module 620 is extended, the central portion of the footrest part 500 is tilted upward and both opposite ends of the footrest part 500 are secured downward.

Although not shown in the drawing, there may be further provided a sliding-fixing member (not shown) rotatably coupled to the other end of the second footrest member 520 and a sliding guide (not shown) provided in the main frame 200 to slide a longitudinal direction so as to support the sliding-fixing member.

The sliding-fixing member and the sliding guide can help the other end of the second footrest member to sliding along the longitudinal direction, without separating from the main frame.

Next, referring to FIG. 7, a variation of the central support part 400 will be described as follows.

FIG. 7 is a side view illustrating a variation of the central support part shown in FIG. 3.

As shown in FIG. 7 (a), the central support part 400 is configured of the plurality of the members mentioned above in the first embodiment. One sliding member 410 arranged closet to the back support part 300 is separated by the operation of the first driving module 610 to slidingly move.

However, the central portion 400 is configured of one member, not the plurality of the members, and it includes an extension frame 420 slidably provided therein.

The entire length of the central support part 400 is adjusted by the sliding motion of the extension frame 420. Accordingly, the same effect can be expected, compared with the central support part configured of the plurality of the members shown in FIG. 7 (a).

In case the back support part 300 is tilted by the folding type bed, the user's abdominal pressure can be minimized.

### Second Embodiment

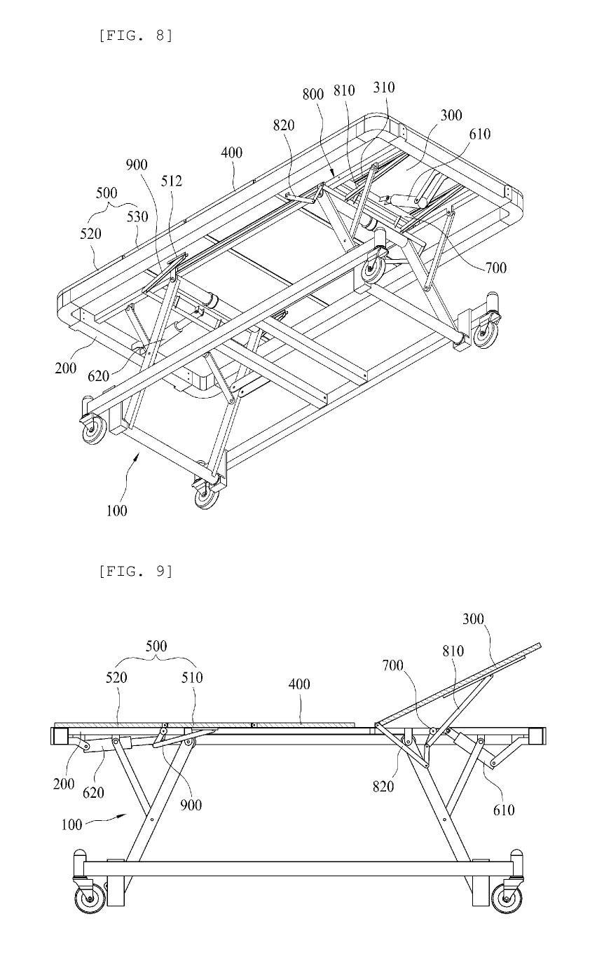

Referring to FIG. 8, a structure of a folding type bed according to a second embodiment of the present invention will be described as follows.

FIG. 8 is a perspective diagram illustrating a structure of a folding type bed according to a second embodiment of the present invention.

A basic structure of the folding type bed according to this embodiment is similar to the basic structure according to the first embodiment, except that the central support part 400 is configured of one member, not the plurality of the members. The length of the central support part 400 cannot be adjusted.

The extension link 820 provided in the first connection module 800 is rotatably coupled to an inner end of the back support part 300, not coupled to the central support part 400.

The back support part 300 is separated, not coupled to the central support part 400. One end of the back support part 300 is configured to slide along the main frame 200 and the other end is positioned outside to be tilted upward by the operation link 810.

Under the structure, in case the first connection module 800 is operated by the first driving module 610, the back support part 300 is separated from the central support part 400 and tilted upward.

Next, referring to FIG. 9, the operations of the back support part 300 and the first driving module 610 will be described in detail as follows.

FIG. 9 is a diagram illustrating the operation of the back support part shown in FIG. 8.

As shown in FIG. 9, the first driving module 610 is extended and the rotary member 700 is rotated in the counter-clockwise direction. After that, the operation link 810 is located in the back side of the back support part 300 and sliding downward to tilt the back support part 300 upward.

Together with that, one end of the extension link 820 is rotatably coupled to the operation link 810 and the other end of the extension link 820 is rotatably coupled to one end of the back support part 300, to rotate on its coupling shaft with the operation link 810 in the clockwise direction. While rotated in the clockwise direction, the extension link 820 applies an external force to slide one end of the back support part 300, without separating along the main frame 200.

Here, the back support part 300 is separated from the central support part 400, such that the central support part 400 may perform no operation.

The other operations and configurations not mentioned above in the second embodiment are identical to the operations and configurations of the first embodiment.

When a particular feature, structure, or characteristic is described in connection with any embodiment, it is submitted that it is within the purview of one skilled in the art to affect such feature, structure, or characteristic in connection with other ones of the embodiments. Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A folding type bed comprising:
a support frame;
a main frame coupled to the support frame to be supported by the support frame at a predetermined height from the ground;
a back support part provided on the main frame, with one end slidable on the main frame;
a central support part of which the length is adjustable by an external force on the main frame, with one end rotatably coupled to one end of the back support part;
a first driving module coupled to the main frame or the support frame, in a state of being extendible in one direction;
a rotary member rotatably coupled the main frame and coupled to the other end of the first driving module, spaced apart a predetermined distance from a coupling shaft with the main frame, to be rotated by the extension of the first driving module; and
a first connection module slidingly coupled to the back support part and rotatably coupled to the central support part simultaneously, in a state of connected with the rotary member, to rotate the rotary member when the first driving module is extended so as to tilt one portion of the back support part and to slidingly move the central support part simultaneously.

2. The folding type bed according to claim 1, wherein the first connection module comprises,
an operation link comprising a middle portion fixedly coupled to the rotary member and one end slidably coupled to a back side of the back support part; and
an extension link comprising one end rotatably coupled to the other end of the operation link and the other end rotatably coupled to the central support part.

3. The folding type bed according to claim 2, wherein the extension link is extendible.

4. The folding type bed according to claim 1, wherein the central support part comprises a plurality of members that are slidable with each other and one of the members located outer comprises one end rotatably coupled to the back support part.

5. The folding type bed according to claim 1, wherein the central support part further comprises,
an extension frame slidably provided therein to slide by an external force, without separating from the central support part.

6. The folding type bed according to claim 2, further comprising:
a footrest part provided on the other portion of the main frame where the back support part is not located, with a middle portion that is able to tilt upward, with making one end not separated from the main frame;
a second driving module configured to tilt the middle portion of the footrest part simultaneously with the motion of the footrest part along the main frame; and
a second connection module comprising one portion slidably coupled to a back side of the footrest, the other portion rotatably coupled to the second driving module and a middle portion rotatably coupled to the main frame.

7. The folding type bed according to claim 6, wherein the footrest part comprises a plurality of members arranged on the main frame in series, in a state of being rotatably coupled to each other.

8. The folding type bed according to claim 7, wherein the outermost one of the members is slidably coupled to the main frame to slide simultaneously with the tilting of the footrest part.

9. The folding type bed according to claim 6, wherein the first driving module and the second driving module have the same structure.

10. A folding type bed comprising:
a support frame;
a main frame coupled to the support frame to be supported by the support frame at a predetermined height from the ground;
a back support part provided on the main frame, with one end slidable on the main frame;
a first driving module coupled to the main frame or the support frame, in a state of being extendible in one direction;
a rotary member rotatably coupled the main frame and coupled to the other end of the first driving module, spaced apart a predetermined distance from a coupling shaft with the main frame, to be rotated by the extension of the first driving module; and
a first connection module slidingly coupled to the back support part and rotatably coupled to one end of the back support part simultaneously, in a state of connected with the rotary member to rotate the rotary member when the first driving module is extended, so as to tilt one portion of the back support part and to slidingly move the back support part simultaneously.

11. The folding type bed according to claim 10, wherein the first connection module comprises,
an operation link comprising a middle portion fixedly coupled to the rotary member and one end slidably coupled to a back side of the back support part; and
an extension link comprising one end rotatably coupled to the other end of the operation link and the other end rotatably coupled to the central support part.

12. The folding type bed according to claim 11, wherein the extension link is extendible.

13. The folding type bed according to claim 10, further comprising:
a footrest part provided on the other portion of the main frame where the back support part is not located, with a middle portion that is able to tilt upward, with making one end not separated from the main frame;
a second driving module configured to tilt the middle portion of the footrest part simultaneously with the motion of the footrest part along the main frame; and
a second connection module comprising one portion slidably coupled to a back side of the footrest, the other portion rotatably coupled to the second driving module and a middle portion rotatably coupled to the main frame.

14. The folding type bed according to claim 13, wherein the footrest part comprises a plurality of members arranged on the main frame in series, in a state of being rotatably coupled to each other.

15. The folding type bed according to claim 14, wherein the outermost one of the members is slidably coupled to the main frame to slide simultaneously with the tilting of the footrest part.

16. The folding type bed according to claim 13, wherein the first driving module and the second driving module have the same structure.
